(19) United States
(12) Patent Application Publication
(10) Pub. No.: US 2025/0088018 A1
(43) Pub. Date: Mar. 13, 2025

(54) Battery Runtime Extender

(71) Applicant: Inventus Power, Inc., Woodridge, IL (US)

(72) Inventors: Bryan Rossman, Warrenville, IL (US); Richard E. VanCamp, Aurora, IL (US); Paul John Kudrna, Naperville, IL (US); Sean Cuda, Chicago, IL (US); Mark Fiedler, Woodridge, IL (US)

(73) Assignee: Inventus Power, Inc., Woodridge, IL (US)

(21) Appl. No.: 18/243,849

(22) Filed: Sep. 8, 2023

(51) Int. Cl. H02J 7/00

(52) U.S. Cl. CPC H02J 7/0045; H02J 7/00034

(57) ABSTRACT

A battery runtime extender may be configured to provide electrical power to an electronic device via electrical terminals disposed internally to the electronic device, such as within a battery compartment. The battery runtime extender may physically mount to the electronic device via fasteners associated with the battery compartment of the electronic device, where the battery runtime extender forms a seal between the housing of the battery runtime extender and the battery compartment of the electronic device that is resistant to ingress of water and/or dust. The electronic device may be configured to be mounted to equipment worn by or otherwise carried by an individual, such as a protective helmet. The battery runtime extender further provides electrical power capacity greater than would be provided by battery cells installed within the battery compartment.

### FIELD

Aspects described herein generally relate to electrical power storage systems. More specifically, aspects of this disclosure relate to a battery runtime extension device for use as a replacement (or supplement) of conventional battery types to provide extended runtime for a portable and/or wearable electronic device.

### BACKGROUND

Batteries come in different shapes and sizes depending on their intended usage. Some batteries may be arranged as packages of battery cells that are assembled together to provide a predetermined power output. These battery packages may be arranged in a durable and sealed housing to protect the batteries from damage. In some instances, these batteries may be inserted within a compartment of a device (e.g., a wearable electronic device) to provide electrical power to accommodate an intended use of that device.

Wearable electronic devices may be utilized to provide certain functionality (e.g., night vision capability, communications capability, etc.) in mobile applications and/or remote location use. Integrated communications equipment and/or weapons gear utilized, for example, by law enforcement and/or military personnel requires increasingly high levels of power storage carried proximate the user's body. In some instances, certain mobile devices may utilize batteries in replaceable battery packages that are designed to provide electrical power to the mobile device over a defined time period. For example, a mobile device may include a battery compartment designed to hold one or more batteries of a particular package, such as a cylindrical cell, a button cell, and the like, where the batteries provide electrical power to perform desired functionality over a defined period of time. For existing devices, providing electrical power to the device for longer than the capabilities of the included batteries may be limited to replacing and/or recharging the depleted batteries. Methods of increasing power storage capability in a device, may be to include additional battery cells and/or use larger battery cells. However, even if possible without a redesign, these solutions may unacceptably increase the size and/or weight of the resulting devices, reducing mobility.

As such, the mobile electrical power storage industry needs increasing power capacity while improving an overall user safety of these systems while simultaneously reducing their size and weight.

### BRIEF SUMMARY

Aspects of the disclosure provide solutions that address and overcome technical problems associated with electrical power limitations associated with limiting power of portable electronic devices to a set of enclosed primary and/or secondary batteries.

Additional aspects of this disclosure may relate to a battery runtime extender for an electronic device and/or a wearable electronic device may include a housing that includes an upper portion and one or more side portions extending downward from the upper portion to form a cavity within which the electronic device is positioned. The upper portion of the housing may enclose electronics and/or electrical circuitry monitoring power flow from the battery runtime extender and to the electronic device. The battery runtime extender may include one or more fasteners capable of physically coupling the housing to the electronic device. Additionally, the battery runtime extender may include two or more contact carriers configured to interface with an electrical power bus of the electronic device to facilitate flow of electrical power from the battery runtime extender to the electronic device. In some cases, a first contact carrier may be used to position a first electrical contact relative to a first physical location of the electronic device and a second contact carrier may be used to position a second electrical contact relative to a second physical location of the electronic device. The electrical contacts of the battery runtime extender may be positioned in the first physical location to allow the first electrical contact to make an electrical and physical connection with a first electrical contact corresponding to a negative terminal of an electrical bus of the electronic device and may be positioned in the second physical location to allow the second electrical contact to make an electrical and physical connection with a second electrical contact corresponding to a positive terminal of an electrical bus of the electronic device. Additional aspects may relate to positioning of the electronic device relative to the housing of the battery runtime extender where, in some cases, the electronic device is at least partially enclosed within the cavity.

Additional aspects of the battery runtime extender may relate to positioning of the electrical contacts of the battery runtime extender relative to exterior surfaces of the battery runtime extender, such that the first contact carrier positions the first electrical contact a first distance below a lower surface of the upper portion of the housing and the second contact carrier positions the second electrical contact a second distance below the lower surface of the upper portion of the housing. Further, in some cases, the first distance below the lower surface of the upper portion of the housing is greater than the second distance below the lower surface of the upper portion of the housing. In some cases, at least a portion of the first contact carrier and the second contact carrier may be formed with a physical shape similar to that of an interior compartment of a battery holder of the electronic device.

Additional aspects of the disclosure may relate to facilitating an electrical and/or physical connection between the battery runtime extender and the electronic device. For example, the battery runtime extender may be physically coupled to the electronic device at one or more different physical locations and/or via a physical shape of the battery runtime extender and the electronic device. In some cases, the battery runtime extender may be physically connected to the electronic device via one or more fasteners. The one or more fasteners may include a first fastener and a second fastener where each of the first fastener and the second fastener extend through associated channels, passages or other pathways through the upper portion of the housing to facilitate creation of a physical connection between the battery runtime extender and the electronic device based on rotation of each fastener or other physical motion of each fastener. In some cases, the first fastener and the second fastener may be threaded screws that may be physically captured within an associated first channel and an associated second channel, respectively. In some cases, the first fastener and the second fastener may be physically rotatable without tools and/or otherwise moved by hand.

Additional aspects of the disclosure may relate to communications and/or providing electrical power to charge battery cells within the battery runtime extender, where an electrical connector may be positioned to facilitate wired communications between the battery runtime extender and a computing device and/or with an electrical charging device or other power supply. In some cases, the electrical connector may be positioned such that the electrical connector is protected from exposure to moisture and/or particles (e.g., dust) when the battery runtime extender is installed for use with the electronic device. In some cases, the battery runtime extender may include one or more mounting surfaces, each comprising a face portion and a fastening mechanism recessed within the mounting surface. In some cases, a battery compartment cover of the electronic device may be physically attached to a corresponding mounting surface of the one or more mounting surfaces via the fastening mechanism, such as via use of a physical component corresponding to a fastener type, such as a threaded insert recessed within the mounting surface. In some cases, the electrical connector used to facilitate communications and/or transfer of electrical power between a computing device or charging device and the battery runtime extender may be protected from moisture and/or dust exposure by being located within a cavity formed between the exterior surface of the battery runtime extender and a battery compartment cover of the electronic device. In some cases, a first mounting surface and a second mounting surface may each include a face portion and a threaded insert recessed within the mounting surface, where the electrical connector is located in a cavity formed and surrounded by one of the first mounting surface and the second mounting surface.

Additional aspects relate to a battery runtime extender that may be configured to provide electrical power to an electronic device via electrical connection points (e.g., electrical terminals) disposed internally to the electronic device, such as within a battery compartment. The battery runtime extender may physically mount to the electronic device via fasteners associated with the battery compartment of the electronic device, where the battery runtime extender forms a seal between the housing of the battery runtime extender and the battery compartment of the electronic device that is resistant to ingress of water and/or particles (e.g., dust). The electronic device may be configured to be mounted to equipment worn by or otherwise carried by an individual, such as a protective helmet. The battery runtime extender further provides electrical power capacity greater than would be provided by battery cells installed within the battery compartment.

### BRIEF DESCRIPTION OF THE DRAWINGS

The present disclosure is illustrated by way of example and not limited in the accompanying figures in which like reference numerals indicate similar elements and in which:

FIGS. 1A and 1B illustrate perspective views of the front and back of an illustrative battery runtime extender according to aspects described herein;

FIG. 2 illustrates a front view of an illustrative battery runtime extender according to aspects described herein;

FIG. 3 illustrates a back view of an illustrative battery runtime extender according to aspects described herein;

FIGS. 4A and 4B illustrate side views of an illustrative battery runtime extender according to aspects described herein;

FIG. 5 illustrates a top view of an illustrative battery runtime extender according to aspects described herein;

FIG. 6 illustrates a bottom view of an illustrative battery runtime extender according to aspects described herein;

FIGS. 7A and 7B illustrate enlarged views of portions of the bottom view of the illustrative battery runtime extender shown in FIG. 6 according to aspects described herein;

FIG. 8 illustrates a perspective view from underneath of an illustrative battery runtime extender according to aspects described herein;

FIG. 9 illustrates an enlarged perspective view from a different vantage point of a portion of the bottom of the illustrative battery runtime extender shown in FIG. 7A according to aspects described herein;

FIGS. 10A-10C illustrate perspective views of an illustrative installation of the illustrative battery runtime extender of FIGS. 1A and 1B according to aspects described herein; and

FIGS. 11A-D illustrate alternative configurations of an illustrative battery runtime extender according to aspects described herein.

FIGS. 12A-12C show illustrative views of battery compartment configurations according to aspects described herein; and

FIGS. 13A and 13B show illustrative block diagrams showing illustrative mechanical and electrical interfaces between a battery runtime extender and a battery compartment of an electronic device, according to aspects described herein.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. It is to be understood that other arrangements may be utilized, and structural and functional modifications may be made, without departing from the scope of the present disclosure. The drawings may not be shown to scale.

It is noted that various connections between elements are discussed in the following description. It is noted that these connections are general and, unless specified otherwise, may be direct or indirect, and that the specification is not intended to be limiting in this respect.

As discussed above, portable electronic devices are commonly used to provide individuals with a certain functionality (e.g., global positioning system activities, night vision capabilities, communications, etc.) for a specified duration of time based on an electric power capacity provided by utilized replaceable primary batteries and/or secondary batteries. Portable electronic devices and/or wearable computing devices may include personal, self-contained, electronic devices easily carried by or worn by an individual. These portable electronic devices may provide one or more functionalities via battery-powered operation including electronic communication, viewing and/or vision enhancement capabilities, audio playback and/or capture capabilities, computing or global positioning capabilities and the like. Illustrative devices may include one or more of a cellular or satellite phone or other communication device, a personal global positioning system unit, a portable computer, a night vision or other vision enhancement device, an audio and/or video playback and/or capture device and/or other similar devices or accessories.

In some cases, individuals engaged in certain occupations and/or activities may face increasing power and data management requirements based on capabilities of devices that are being developed to provide portable electronic functionalities through use of body-worn devices. For example, individuals (e.g., warfighters, law enforcement personnel, etc.) may wear a protective garments and/or a protective helmet when performing certain activities or duties. While some portable electronic devices may be configured to receive electrical power via a personally worn energy storage device (e.g., a conformal wearable battery), many other electronic devices fail to include a connector capable of wired connection to the personally worn energy storage device. In such cases, the portable electronic devices may rely on a fixed configuration of primary battery cells and/or secondary battery cells. In doing so, the electronic device is limited to a defined operational time limited by capacity of the removable primary and/or secondary batteries utilized by the electronic device.

For example, some electronic devices may be designed to be self-contained due to a mounting or carrying location relative to a human's body. For example, a helmet-mounted device may be designed to be powered by or otherwise receive power via a battery pack mounted separately on the helmet and/or may be included as part of a set of helmet-mounted electronics. In some cases, at least a portion of a helmet-mounted electronic device may be mounted on a portion of the helmet. In some cases, the helmet-mounted device may be powered via one or more primary batteries and/or secondary batteries, wherein each of the primary battery cells and/or secondary battery cells may be enclosed, during use, within a sealed battery compartment or holder. However, this power limitation may limit usable functionality of the electronic device. While the primary and/or secondary batteries may be replaced or recharged as needed, often this is not practicable. For example, when an individual is in the field, replacement of depleted battery cells may not be easily performed and/or the electronic device may stop operation at an inconvenient time, thereby subjecting the individual to a potentially unsafe condition.

As mentioned above, protective helmets may be worn by military and/or law enforcement personnel to protect the head and face from various types of injuries, including ballistic and impact injuries. To improve their performance and/or increase their safety electronic devices such as night vision goggles, helmet-mounted display units, camera systems, sensors, and/or other components may be used or otherwise incorporated in modern protective helmets. These electronic components have power needs, that may be limited due to size and/or capacity of primary or secondary batteries carried by the electronic devices. To improve operational time of the electronic device(s), a battery runtime extender may interface with the internal power system of an electronic device, such as via a battery interface originally designed for use with primary and/or secondary battery cells. While a portable electronic device may include an electrical connection interface through which an external power supply may be connected via an internal or external cable, an internal cable may add weight or take up unnecessary space and an external cable, such as to a body-worn power supply, may be a snag hazard or otherwise may limit movement.

In some cases, the battery runtime extender may be physically coupled to the electronic device via fasteners or fastener types associated with a battery compartment cover of the electronic device, wherein the electronic device receives electrical power from the battery runtime extender via electrical terminals or contacts within the battery compartment. Additionally, for added stability, the battery runtime extender may be designed to physically rest atop the electronic device when installed. In some cases, portions of the battery runtime extender may surround, or partially surround, at least a portion of the electronic device. While certain battery runtime extender configurations may be discussed with reference to a helmet mounted device and/or a particular electronic device configuration, a same or similar battery runtime extender may be configured for use with other portable electronic devices utilizing replaceable primary or secondary batteries.

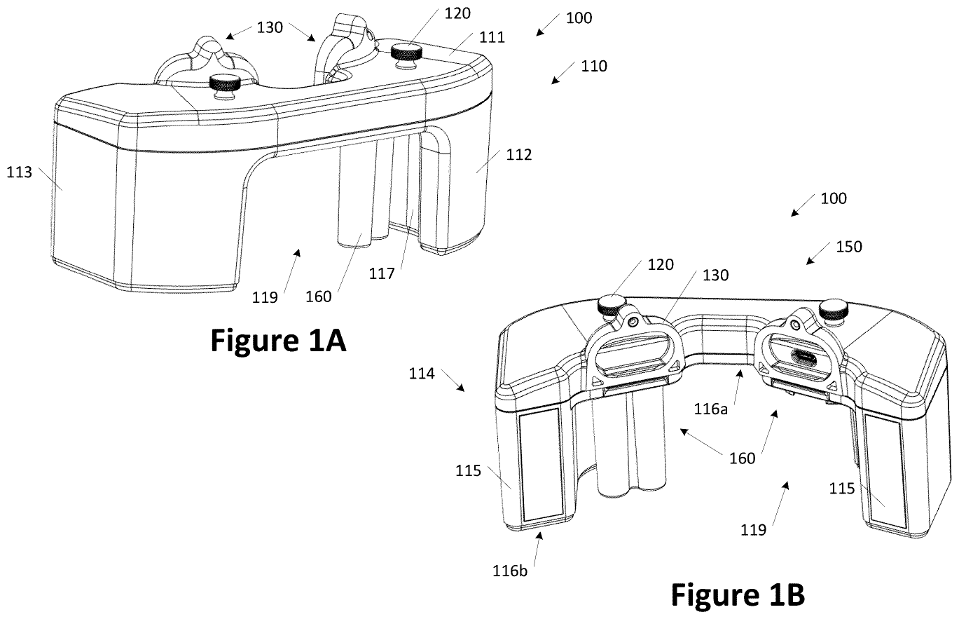

FIGS. 1A and 1B illustrate perspective views of the front and back of an illustrative battery runtime extender 100 according to aspects described herein. For example, FIG. 1A shows an illustrative perspective front view 110 of the battery runtime extender 100 and FIG. 1B shows an illustrative perspective back view of the battery runtime extender 100. The exterior of the battery runtime extender 100 includes a top surface 111, a front surface 112, a left surface 113, a right surface 114, a back surface 115, a bottom surface 116a and a bottom surface 116b, and an inner surface 117. A cavity 119 is formed within the battery runtime extender 100 and may be bounded by the inner surface 117 and the bottom surface 116a. Two or more device electrical system interface components 160 may extend into the cavity 119 from the bottom surface 116a. The electrical system interface components 160 may include electrical contacts to electrically interconnect an internal power source (e.g., one or more rechargeable battery cells) of the battery runtime extender 100 with an electrical system of the electronic device via electrical contacts of a battery power interface within one or more battery compartments of the electronic device.

Extending upward from the top surface 111 are one or more fasteners 120 that extend from the top surface through a channel or passage to extend through the bottom surface 116a of the upper portion 211 of the housing. For example, the fastener 120 may be a thumb screw or other fastener that may be rotatably fastened to a threaded insert or component on a housing of an electronic device. However, the fastener 120 may be one or more different fasteners capable of securing the battery runtime extender 100 to an external electronic device, such as a clamping mechanism, a threaded fastener (e.g., a screw), a tension-based fastener, a compression fastener (e.g., a clamping device) or the like. Each of the fasteners 120 may be used to mechanically couple the battery runtime extender 100 to a corresponding fastener component associated with securing a battery compartment cover to the electronic device. As such a portion of the battery runtime extender provides the functionality of a battery compartment cover to prevent ingress of liquids and/or particulates into the battery compartment of the electronic device. The battery compartment cover may be secured by fasteners to cover a battery compartment opening on the electronic device, where the battery compartment opening is positioned at one end of the battery compartment. As illustrated in FIGS. 1A and 1B, the fastener 120 may be a threaded fastener (e.g., a screw, a thumb screw, etc.) that is received in a threaded hole or threaded insert associated with or arranged along the battery compartment opening of the electronic device. The fastener 120 utilized with the battery runtime extender 100 may be chosen, or otherwise configured to be, the same type of fastener utilized to secure a battery compartment cover to cover a battery compartment opening of the electronic device such as to provide a seal to prevent ingress of water, particles, and/or the like. In some cases, the electronic device may utilize a clamping mechanism to secure a battery compartment cover to seal a battery compartment opening against ingress of liquids or particles. A seal created between structural and/or sealing components defining the battery compartment opening of the electronic device and corresponding structural and/or sealing components of the battery runtime extender 100 may create a seal similar to a seal between the battery compartment cover and the battery compartment opening. In such cases, the fastener 120 may be selected as one of a clamping component or a clamping surface that corresponds to the clamping component physically associated with the battery compartment opening. In some cases, the fastener type may be selected as a same fastener type utilized by an existing battery compartment cover of the electronic device, which helps to provide a similar compressive force on the seal.

In some cases, a device interface extension 130 may extend upward from the top surface 111, such as at an edge of the top surface 111. Features of the device interface extension 130 may be seen in the rear perspective view 150. The device interface extension 130 may be used to connect with a component of the electronic device (not shown) to which the battery runtime extender 100 is powering. For example, the device interface extension 130 may be configured to connect, via a fastening mechanism, to a battery compartment cover of a battery compartment of the electronic device. In some cases, the battery compartment cover of the electronic device may remain physically attached to the electronic device (e.g., via a hinged mechanism) such that when the battery compartment cover is physically attached to the device interface extension 130, this physical connection provides an additional mechanical connection between the battery runtime extender 100 and the electronic device. In some cases, the battery compartment cover of the electronic device may be detachable from the electronic device. In some cases, the battery compartment cover of the electronic device may be fastened via two or more fasteners, so that corresponding fastener components may be included in or with the battery runtime extender 100. For example, for each threaded fastener associated with the battery compartment cover, a corresponding threaded insert may be incorporated within the housing of the device interface extension 130. Similarly, if a fastener comprises a clamping component, a corresponding clamping surface may be provided on or near the device interface extension 130.

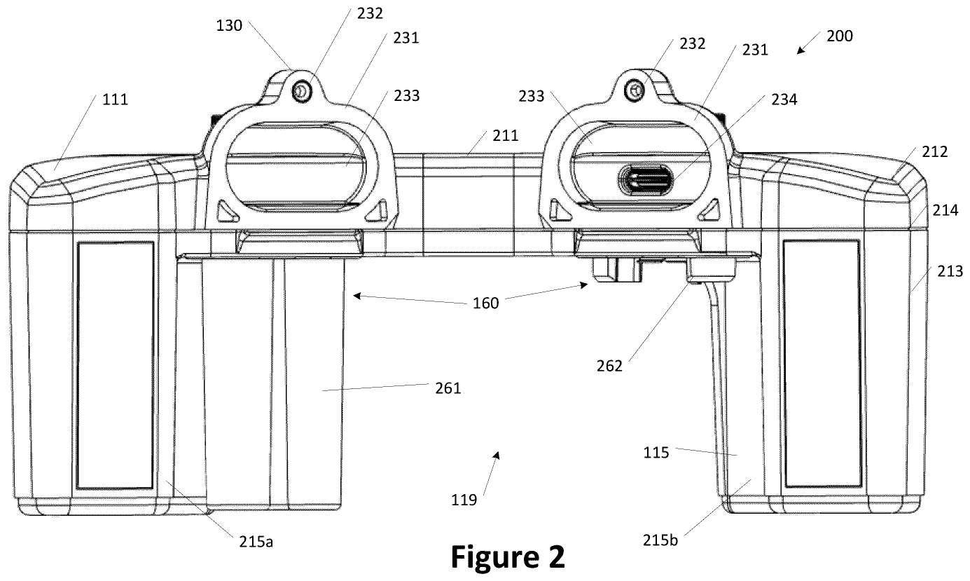

FIG. 2 illustrates a rear view of an illustrative battery runtime extender 100 according to aspects described herein. The battery runtime extender 100 may include an upper portion 211 and one or more side portions 215a and 215b extending downward from the upper portion 211. The one or more side portions 215a and 215b may enclose one or more battery cells that form a portion of the power bus of the battery runtime extender 100. As mentioned above, the upper portion 211 may enclose electronics that are configured to monitor and/or control electric power flow to and from the battery runtime extender 100. In some cases, the electronics may be configured to communicate with an external device via a connector 234.

The battery runtime extender 100 has a housing that encloses the electronics, electric circuitry, and the battery cells. The housing may be formed from multiple parts, such as an upper shell 212, and a lower shell 213, where the upper shell 212 and the lower shell 213 may be sealed together to form the housing of the battery runtime extender 100. The lower shell 213 may include the side portions 215a and 215b and one or more features configured to position the electrical contacts of the battery runtime extender 100 near electrical contacts forming a most negative portion of the power bus of the electronic device and a most positive portion of the power bus of the electronic device. In some examples, the side portions 215a and 215b may be positioned on each side of the electronic device while the electronic device is partially enclosed in the cavity 119. The molded housing components may form a sealed case, such as at the seam 214. Each of the housing components may be formed by a molding process, for example, an injection molding process. The molded casing may be formed of a polymeric material such as, polycarbonate (PC), polypropylene (PP), or similar materials known to one skilled in the art. The polymeric material may be a filled or unfilled polymer. In some cases, the housing may be made of a thermoplastic elastomer (TPE) material, a thermoplastic urethane (TPU) material, a thermoplastic vulcanizates (TPV) material, or other similar material.

The housing may be sealed to prevent ingress of solid material and/or liquid material, for example, according to an internationally recognized or standardized ingress protection (IP) rating system. The housing may feature a seam 214 between two components or portions of the housing that is sealed to encase the battery cell within the housing. For example, the upper shell 212 and the lower shell 213 may be sealed using a method such as laser welding to permanently join the upper shell 212 and the lower shell 213 together. In some cases, the seal produced at the seam 214 between the upper shell 212 and the lower shell may satisfy requirements of an International Electrotechnical Commission (IEC) IP67 rating for preventing dust and water ingress to the case and creating a water-tight fit between the electrically conductive component and the case in which the electrically conductive component is disposed. The IP67 rating is specified by the Ingress Protection Code (IP Code) IEC standard 60529. The equivalent European standard is EN 60529. The IP Code also may be referred to as the International Protection Code. The IP Code classifies and rates a degree of ingress protection provided by mechanical casings and electrical enclosures for electronic equipment against intrusion, dust, accidental contact, and liquid (e.g., water). In the IP67 rating, the first digit (i.e. ‘6’) specifies a level of protection offered against ingress of solid objects, while the second digit (i.e. ‘7’) specifies a level of protection offered against ingress of liquids. The larger the value of the digit specifying the level of protection, the greater the amount of protection offered. For example, an IP67 rating specifies total protection against dust ingress and protection against short periods of immersion in water. An IP68 rating specifies dust resistance and immersion in 1.5 meters of freshwater for up to 30 minutes duration.

A reliable seal, for example, an IP67 rated seal, may be desirable and beneficial for protection and maintenance of batteries enclosed in environmentally protected housings. For example, in dusty, sandy, rainy, and/or wet environments, an improperly sealed system may fail early if contaminants such as water, dust, dirt, and/or sand get into the battery/batteries enclosed in the housing of the battery runtime extender 100. A rechargeable battery runtime extender 100 may be worn or otherwise attached to an electronic device worn or carried by a user. The battery runtime extender 100 may be subjected to environmental conditions that may cause shock or include a force applied to the exterior of the battery runtime extender 100 that may physically deform at least a portion of the battery runtime extender 100 while also being exposed to moisture. A reliable seal may facilitate longer battery life and utility for the user regardless of environmental conditions that the battery runtime extender 100 may be subjected.

In some cases, the battery runtime extender 100 may partially enclose an exterior housing of the electronic device within the cavity 119 that is at least partially defined by the upper portion 211 and the two side portions 215a and 215b. In some cases, one or more battery compartments of the electronic device, with a battery compartment cover being removed, may open upwards towards the upper portion 211 to interface with the battery runtime extender's electrical system interface components 160 including a first electrical connection portion 261 and a second electrical connection portion 262. The first electrical connection portion 261 and the second electrical connection portion 262 may be electrical system interface components, such as a contact carrier, that may hold and/or position electrical contacts of the battery runtime extender 100 in position to interface with the electronic device's electrical system within one or more battery compartments of the electronic device. Each contact carrier may have a physical shape that corresponds to an interior of the battery compartment of the electronic device. In some cases, the first electrical connection portion 261 may be configured to physically locate a first electrical contact (e.g., a negative charge terminal) within a battery compartment of the electronic device to create an electrical connection at a negative charge terminal associated with a most-negative charge portion of an electrical bus within the electronic device. Similarly, the second electrical connection portion 262 may be configured to physically locate a second electrical contact (e.g., a positive charge terminal) within a battery compartment of the electronic device to create an electrical connection at a positive charge terminal associated with a most-positive charge portion of the electrical bus within the electronic device. For examples, the first electrical connection portion 261 and/or the second electrical connection portion 262 may be received within a battery compartment of the electronic device to locate the first and second electrical contacts near the respective negative and positive charge terminals of the electronic device.

To facilitate this positioning of electrical contacts within one or more battery compartments of the electronic device, a battery compartment cover of the electronic device may remain open. In some cases, the battery compartment cover may remain attached (e.g., a hinged battery compartment cover) to the electronic device. As such,, battery runtime extender 100 may include a number of device interface extensions (e.g., the device interface extensions 130) that match the number of battery compartment covers of the electronic device. As shown in FIG. 2, the battery runtime extender 100 includes two device interface extensions 130, where each device interface extension 130 include a face 231, a threaded portion (e.g. a threaded insert 232) within the face 231, a recessed portion 233 surrounded by the face 231, and in some cases, the connector 234 may be physically located within the recessed portion 233 of one of the device interface extension 130. In some cases, each battery compartment cover may be physically connected to a corresponding device interface extension 130 forming a seal, such as an IP67 rated seal between the face 231 and the battery compartment cover. A fastener (e.g., a threaded screw, a thumb screw or other threaded component) may facilitate creation of the seal by rotatably connecting the fastener to the threaded insert 232.

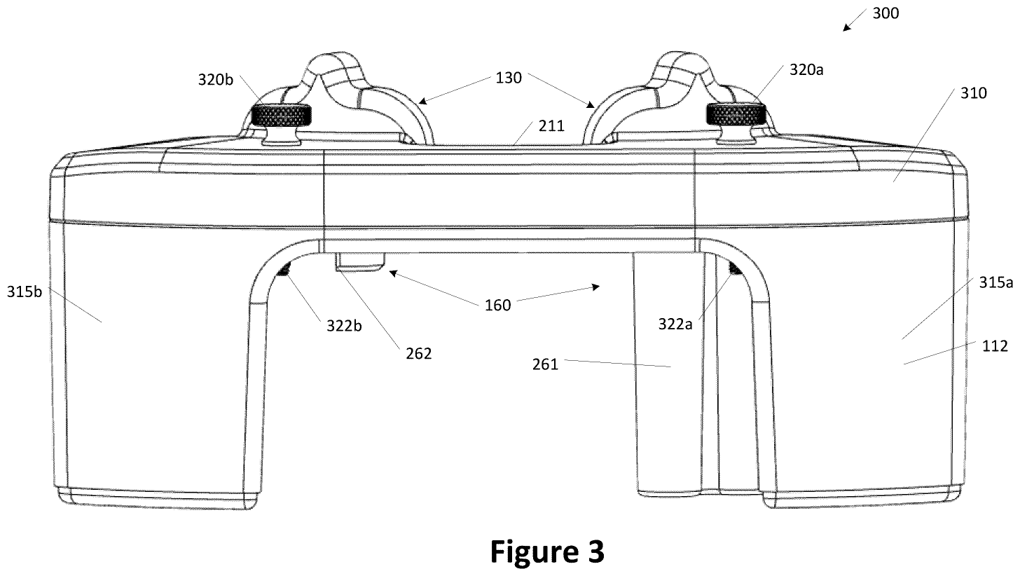

FIG. 3 illustrates a front view 300 of an illustrative battery runtime extender 100 according to aspects described herein. The front view 300 shows a view of the battery runtime extender 100 facing outward or otherwise away from the body of an individual wearing or carrying the electronic device being powered by the battery runtime extender 100. Visible in the front view 300 is the upper portion 310 of the battery runtime extender 100 is a surface of the device interface extension 130 opposite the face 231, a front surface 112 of the upper portion 211, a front surface 315a and 315b of the side portions 215a and 215b, a right thumbscrew 320a, and a left thumbscrew 320b. As discussed above, the electronic device may include one or more battery compartments, where the battery runtime extender 100 may include corresponding components to interface with each of the one or more battery compartments. Shown here, the thumbscrews 320a and 320b may facilitate a mechanical connection between the battery runtime extender 100 and a threaded component (e.g., a threaded insert) of a corresponding battery compartment. For example, a user may tighten the thumbscrews 320a and 320b (or other fastener types if applicable) by hand to interconnect with the corresponding fastener components of the battery compartment(s) of the electronic device (e.g., threaded inserts similar to the threaded portion 322a and 322b).

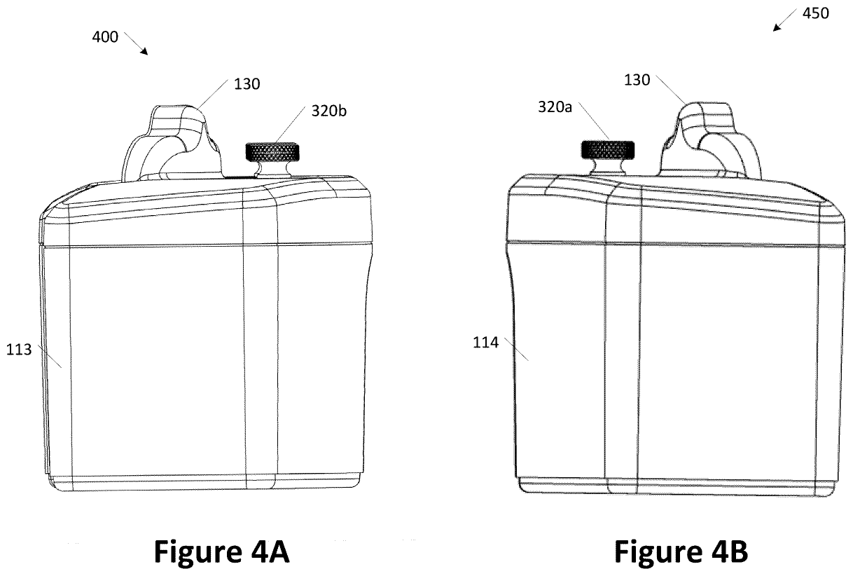

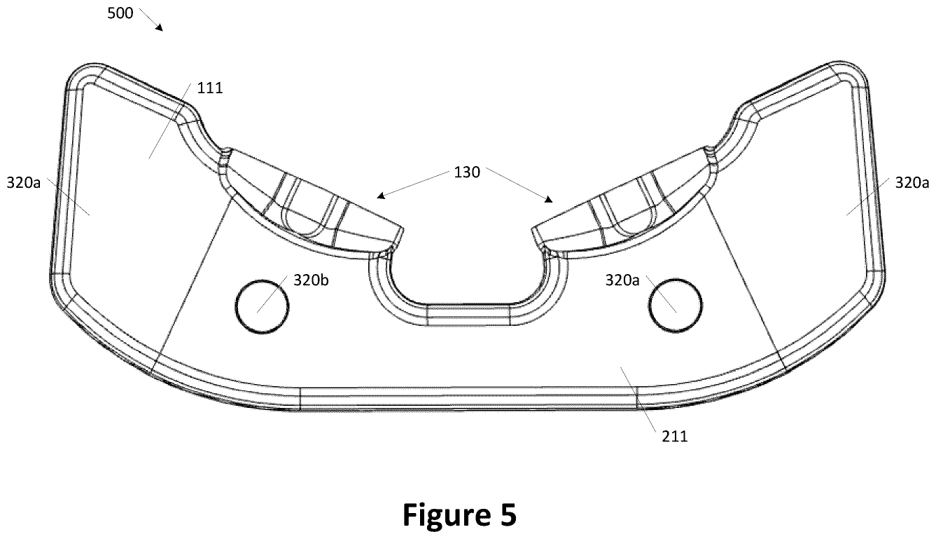

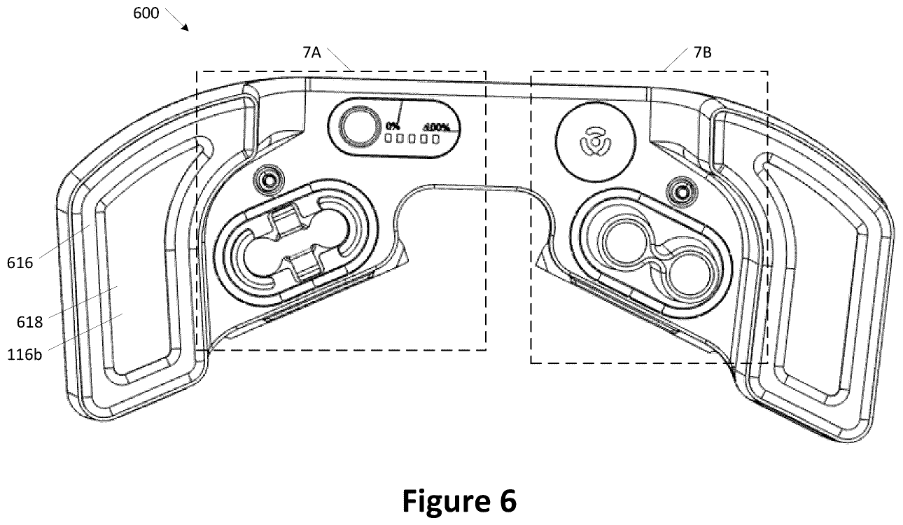

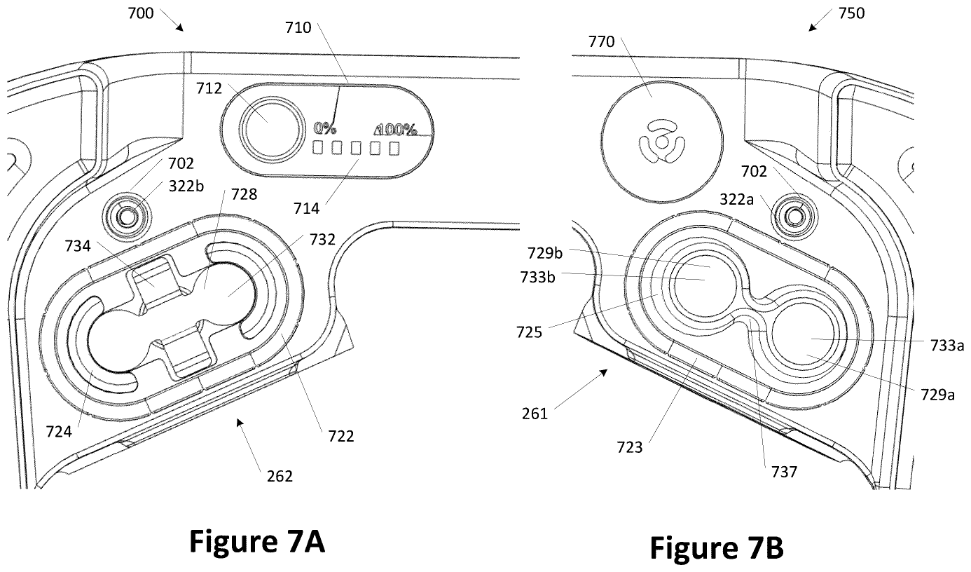

FIG. 4A shows an illustrative left side view 400 of the battery runtime extender 100, FIG. 4B shows an illustrative left side view of the battery runtime extender 100, and FIG. 5 shows an illustrative top view 500 of the battery runtime extender 100, according to aspects described herein. FIG. 6 illustrates a bottom view 600 of the illustrative battery runtime extender 100 according to aspects described herein. Further, FIGS. 7A and 7B illustrate enlarged views of portions of the bottom view of the illustrative battery runtime extender shown in FIG. 6 according to aspects described herein. As shown in FIG. 6, the bottom surface (e.g., bottom surface 116b) of each side portion may include a raised portion 616 surrounding a recessed portion 618. In some cases, the raised portion 616 and the recessed portion 618 may be made of a same material. In some cases, the recessed portion 618 may be made of a same material as the rest of the housing of the battery runtime extender 100, while the raised portion 616 may be made of a second material. For example, the housing may be made of a rigid material, while the raised portion 616 may be made of a resilient material that may include shock absorbing characteristics.

FIG. 7A shows a closeup view 700 of a portion of the bottom surface 116a. As discussed above, the threaded portion 322b of a thumbscrew 320 or other fastener may extend through the bottom surface 116a of the battery runtime extender 100 via a passage 702. The passage 702 may be shaped to capture a portion of the thumbscrew 320 such that the thumbscrew 320 is captive and cannot be separated from the housing. In some cases, the passage 702 may be physically separate from the interior of the housing. The bottom surface 116a may also include a display 710 that may include a button 712 and one or more indicators 714 (e.g. a power gauge). The button 712 may allow a user to physically interact with the display 710 to facilitate a view of the power status of the battery cells of the battery runtime extender via the indicator or display 714. The indicator 714 may include one or more light emitting diodes that may be illuminated to indicate a relative power level of the battery cells. In the illustrative example, the indicator 714 includes a number (e.g., 5 or more or less) of LEDs that each represent approximately 20% (or other percentage) of battery life. In some cases, the display 714 may include an alphanumeric display, a graphical display, an analog display and/or the like.

As discussed above, the second electrical connection portion 262 facilitates an electrical connection to a positive electrical terminal of the electronic device powered by the battery runtime extender 100. FIG. 7A shows an illustrative bottom view of the second electrical connection portion 262, which includes a surface 722, a guide 724, and an electrical contact 732. The surface 722 and the guide 724 may be shaped to facilitate a physical connection with an associated battery compartment and/or enhance stability of the physical and/or electrical connection within the battery compartment. In the illustrative example, the shape of the surface 722 and the guide 724 are shaped to form a physical connection with a battery compartment configured to hold two cylindrical batteries (e.g., batteries with an “AA” form factor, an “AAA” form factor, an 18650 Lithium Ion cell form factor, a 14500 form factor, a CR123A form factor, and the like). The guides 724 may be used to position the electrical contact 732 within the battery compartment to align a surface 728 with an electric terminal within the battery compartment. Additionally, the guides 724 may allow alignment of the threaded portion 322b of the thumbscrew with the threaded component of the battery compartment. The electrical contact 732 may also include a contact spring component 734 that may be used to provide a tensioned fit between the surface 728 of the electrical contact 732 and the electric terminal(s) within the battery compartment to ensure a continuous electrical connection is maintained. When the thumbscrew 320 is tightened, a seal is formed between a surface of the battery compartment and the surface 722. This seal may prevent ingress of solid material and/or liquid material into the battery compartment of the electronic device, for example, according to an IP67 rating, IP68 rating, or other ingress protection rating.

FIG. 7B shows a closeup view 750 of a portion of the bottom surface 116a. As discussed above, the threaded portion 322a of a thumbscrew 320 or other fastener may extend through the bottom surface 116a of the battery runtime extender 100 via a passage 702. The passage 702 may be shaped to capture a portion of the thumbscrew 320 such that the thumbscrew 320 is captive and cannot be separated from the housing. In some cases, the passage 702 may be physically separate from the interior of the housing. The bottom surface 116a may also include a vent 770 that may be used to equalize pressure and/or allow venting of gases from an interior of the battery runtime extender 100.

As discussed above, the first electrical connection portion 261 facilitates an electrical connection to a negative electrical terminal of the electronic device powered by the battery runtime extender 100. FIG. 7B shows an illustrative bottom view of the first electrical connection portion 261, which includes a surface 723, a guide 725, and one or more electrical contacts 733a and 733b. The surface 723 and the guide(s) 725 may be shaped to facilitate a physical connection with an associated battery compartment. In the illustrative example, the shape of the surface 723 and the guide 725 are shaped to form a physical connection with a battery compartment configured to hold two cylindrical batteries (e.g., batteries with an “AA” form factor, an “AAA” form factor, an 18650 Lithium Ion cell form factor, a 14500 form factor, a CR123A form factor, and the like). The guides 725 may be used to position the electrical contact(s) 733a and 733b within the battery compartment to align corresponding surfaces 729a and 729b with an electric terminal within the battery compartment. Additionally, the guides 725 may allow alignment of the threaded portion 322a of the thumbscrew with the threaded component of the battery compartment. In some cases, a spacer portion 737 may be used to separate the electrical contacts 733a and 733b to ensure that each electrical contacts 733a and 733b are spaced correctly to contact the corresponding terminal within the battery compartment. In some cases, the length of the guide 725 may correspond to a length of the battery compartment and/or the battery cell type being replaced within the electronic device. In some cases, the battery terminal within the battery compartment may be a spring, or other such component, that ensures a continual physical and electrical connection between the surfaces 729a and 729b of the electrical contacts 733a and 733b with corresponding electrical terminals within the battery compartment.

The battery sizes, shapes and/or configuration of a battery compartment as discussed herein are illustrative and other sizes, shapes and configurations may be used with corresponding modifications to the shapes and/or configurations of the components shown in FIGS. 7A and 7B.

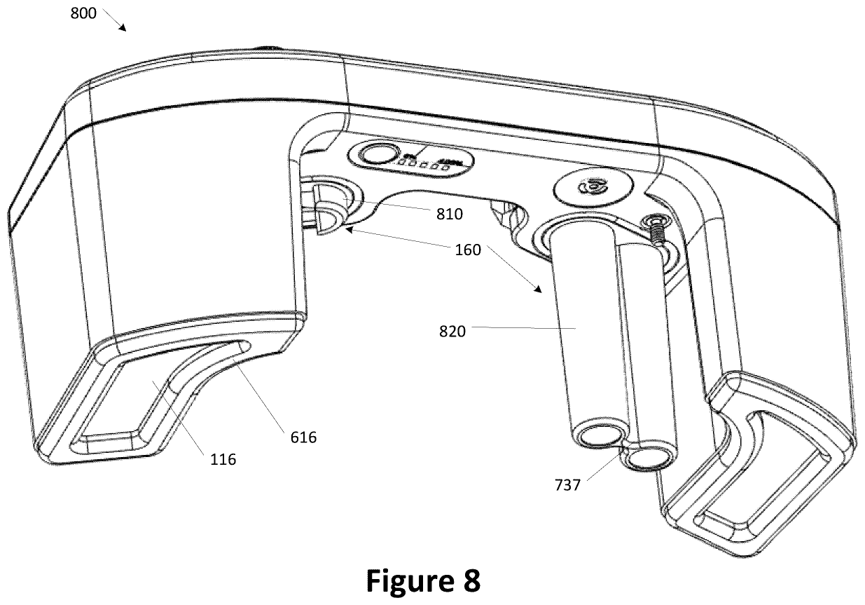

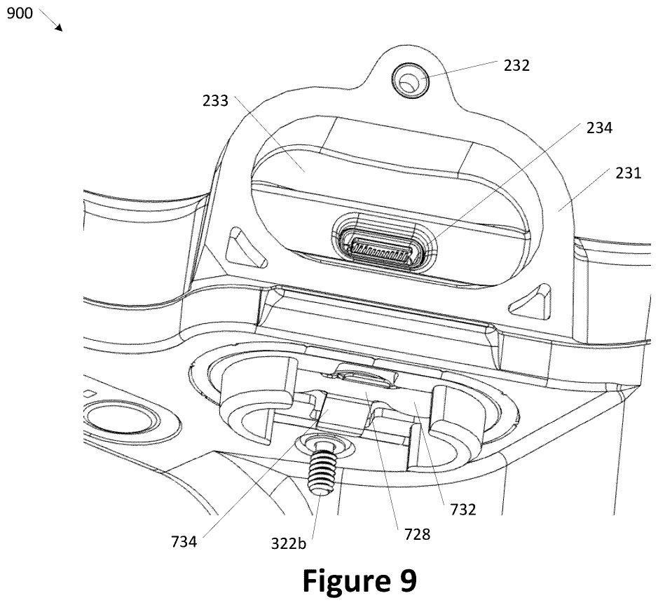

FIG. 8 illustrates a perspective view 800 from underneath of an illustrative battery runtime extender according to aspects described herein. As can be seen. the shape of the guide 810 is shown to be at least partially cylindrical with a radius similar to a battery type being replaced within the corresponding battery compartment of the electronic device. Similarly, the guide 820 is shown to be a combination of two generally cylindrical shapes separated by the divider or spacer portion 737 to ensure proper spacing. In some cases, the spacer portion 737 may define at least a portion of a contact carrier holding electrical contact components in position to interface with corresponding electrical terminals within the battery compartment of the electronic device. The guide 820 may be formed from a material similar to that of the housing of the battery runtime extender. FIG. 9 illustrates an enlarged perspective view 900 from a different vantage point of a portion of the bottom of the illustrative battery runtime extender shown in FIG. 7A according to aspects described above.

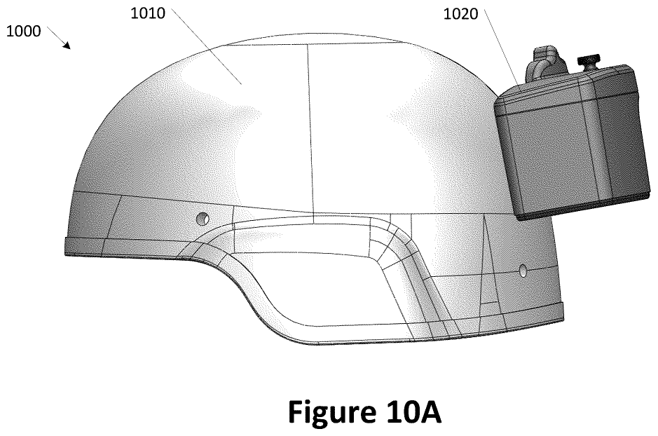

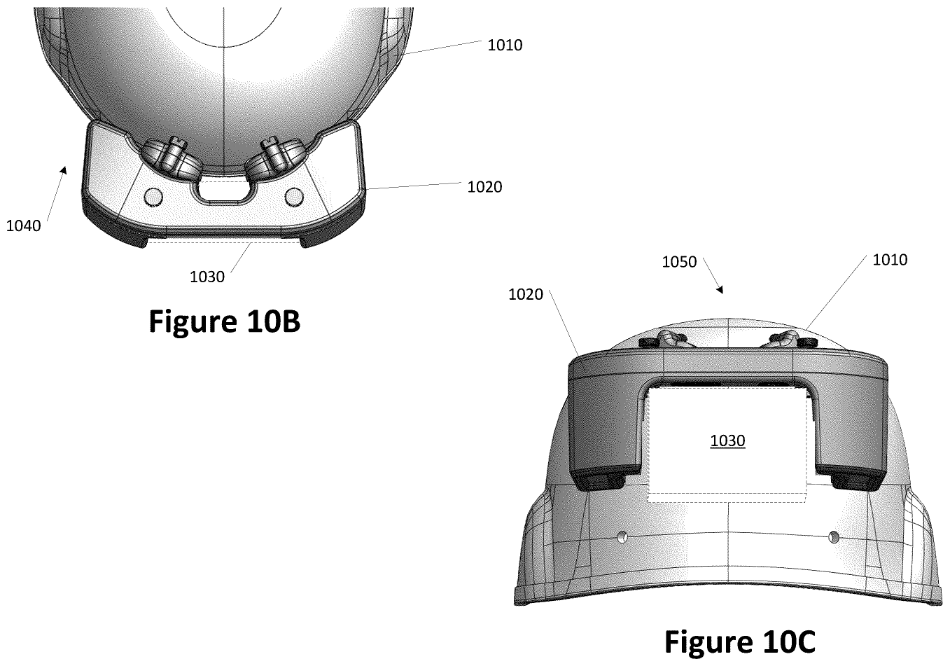

FIGS. 10A-10C illustrate perspective views of an illustrative installation of the illustrative battery runtime extender of FIGS. 1A and 1B according to aspects described herein. For example, FIG. 10A shows an illustrative side view 1000, FIG. 10B shows an illustrative partial top view 1040, and FIG. 10C shows and illustrative rear view 1050 of a use of a battery runtime extender 1020 in use with an electronic device 1030 installed on a protective helmet 1010. In some cases, the battery runtime extender 1020 may be sized such that the protective helmet 1010 extends past the outside edges of the battery runtime extender 1020. In some cases, a portion of the runtime extender (e.g., a top corner) may be visible due to a curvature of the protective helmet 1010. A weight of the battery runtime extender may be 1 kilogram or less. In some configurations, the electronic device 1030 may be physically anchored to the protective helmet 1010 and the battery runtime extender 1020 may be physically connected to the battery runtime extender 1020 via use of a fastener associated with a battery compartment cover being physically attached to the battery runtime extender 1020 (e.g., via the and electrically attached to the electronic device 1030 via the device interface extension 130, as discussed above. Similarly, one or more fasteners (e.g., the fasteners 120) of the battery runtime extender 1020 may be physically attached to a battery compartment of the electronic device 1030, as discussed above. Additionally, the electrical interface components 160 of the battery runtime extender 1020 may facilitate a further physical connection to the electronic device 1030 and may provide additional physical stability to the physical connection, while simultaneously facilitating the electrical connection between the electronic device 1030 and the battery runtime extender 1020.

While the drawings represent the device interface extensions 1030 and the battery interface components as being fixedly attached to the battery runtime extender 1020, such as to interface with a particular electronic device 1030, in some cases, electrical and/or physical interface components of the battery runtime extender may be configurable, to accommodate physical and/or electrical connections to electronic devices of varying configurations. For example, a size, shape and/or configuration of the electrical interface components 160 may be modified to allow for different battery compartment configurations for particular electronic devices, such as to accommodate designs for different battery cell types, differing numbers of battery cells, battery cell layout within the battery compartment, etc.). Similarly, fasteners, such as the fasteners 120 and/or the device interface extensions 130 may be modifiable, or otherwise provided in different configurations, styles, types, or shapes to accommodate differing battery compartment designs of an associated electronic device 1030.

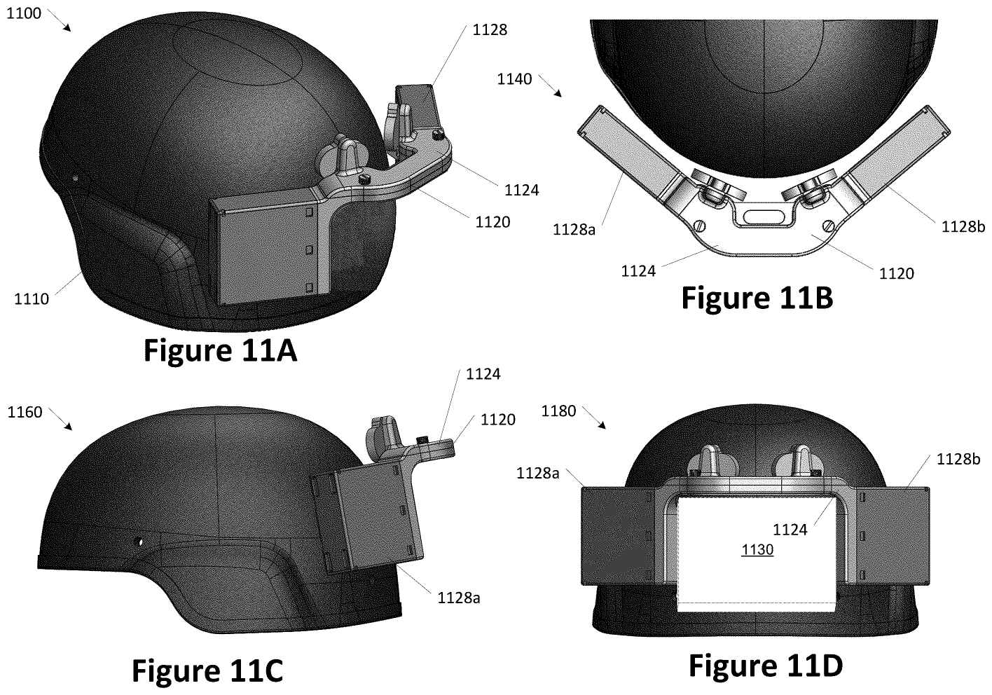

FIG. 11A-D illustrates an alternative configuration of an illustrative battery runtime extender according to aspects described herein. FIG. 11A shows an illustrative perspective view 1100 of an alternate configuration of the illustrative battery runtime extender 1120 comprising a body structure 1124 that includes electrical system control and/or monitoring components, and one or more removable battery packs 1128. FIG. 11B shows a partial top view 1140, FIG. 11C shows a partial side view 1160, and FIG. 11D shows a rear view 1180. FIGS. 11A-11C show the illustrative battery runtime extender 1130 in a position adjacent a protective helmet 1110, without an associated electronic device to illustrate approximate positioning of the battery runtime extender 1120 with respect to the protective helmet 1110. The illustrative battery runtime extender 1120 also includes alternate designs for the fasteners and device interface extensions. In some cases, the removable battery packs 1128 may be attached and/or removed via at least a partial twisting motion. In some cases, the removable battery packs 1128 may be attached and/or removed via at least a partial sliding motion. In some cases, the removable battery packs may be additionally secured via a clip or other fastening device that may require manual manipulation to release the removable battery pack 1128 from the central structure 1124 of the battery runtime extender 1120.

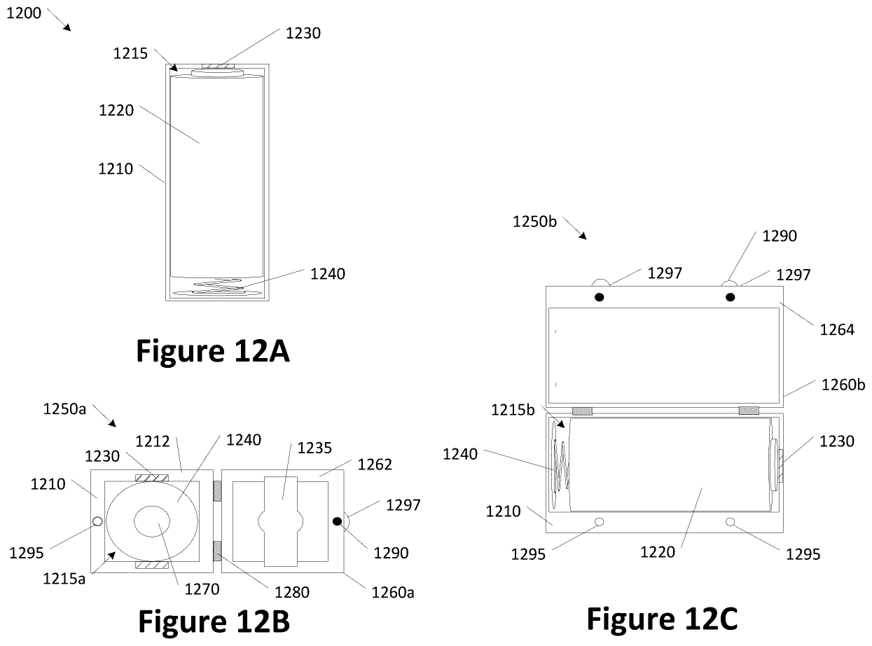

FIGS. 12A-12C show illustrative views of battery compartment configurations according to aspects described herein. FIG. 12A shows an illustrative battery compartment 1200 of an electronic device. The battery compartment 1200 includes physical components configured to securely hold a removable primary or secondary battery 1220 and electrical connection points (e.g., electrical terminals 1230, 1240) configured to facilitate transfer of electrical power between the primary or secondary battery and the electronic device. Here, the battery compartment 1200 includes a plurality of side walls 1210 forming an internal cavity 1215 configured to receive one or more batteries, such as battery 1220 (e.g., a primary battery, a secondary battery, etc.). Internal to the cavity 1215, the battery compartment 1200 includes positive and negative battery terminal connections, such as electrical terminals 1230 and 1240, respectively. A design of the battery compartment may vary, such as with the number and orientation for installing the one or more batteries within the cavity 1215. For example, FIG. 12B shows a battery compartment 1250a configured to hold a battery with a first orientation with respect to the opening 1215 and FIG. 12C shows a second battery compartment 1250b configured to hold a battery 1220 inserted with a second orientation with respect to the opening 1215b.

In FIG. 12B, the open battery compartment 1250a is shown as having sidewalls 1210 forming a rectangular internal cavity 1215 holding a battery 1240. The battery, as oriented within the cavity 1215a, is positioned such that an electrical terminal (e.g., a positive electrical terminal 1270) is positioned facing outward from the cavity 1215a. As shown, the electrical connection to the battery is not closed unless the battery compartment 1250a is closed. Here, the battery compartment 1250a includes a battery compartment cover 1260a (shown in a hinged open configuration). The battery compartment cover 1260a may be detachable from the battery compartment sidewalls 1210 (not shown) or may be attached (e.g. via one or more hinges 1280) near an edge of a sidewall 1210. In the illustrative example, the electrical terminal 1270 of the battery 1240 does not contact a corresponding electrical terminal 1230 located at one or more sidewalls. Here, a conductive component (e.g., a metal strip) may be positioned on the battery compartment cover 1260a to facilitate the electrical connection between the battery terminal 1270 and the electrical terminal(s) 1230 on the sidewall 1210. In some cases, the battery compartment cover 1260a may be physically fastened to the battery compartment 1250a via fastener components such as, for example, a screw, a clamp, or other fastener capable of securely fastening the battery compartment cover 1260a to the battery compartment 1250a. In some cases, when secured, the fastener may facilitate a seal between the surface of a battery compartment sidewall 1210 surrounding the cavity 1215a and a surface 1262 of the battery compartment cover 1260a. In some cases, the seal may prevent ingress of liquids and/or particulates into the interior cavity 1215a of the battery compartment. In some cases, a seal (e.g., a gasket, an o-ring, etc.), not shown, may also be used. In the illustrative example, a threaded insert 1295 may receive a threaded portion of a screw passing through the battery compartment cover 1260a, where the screw maybe rotated via an upper portion 1297 of the screw, by hand and/or using tools.

FIG. 12C shows another configuration of an illustrative battery compartment 1250, where the battery compartment cover 1260b may be configured to open laterally, such that the battery compartment opening 1215b may laterally receive the battery 1220, such that both the positive electrical contact 1230 and the negative electrical contact 1240 are captured in the sidewalls 1210 of the battery compartment.

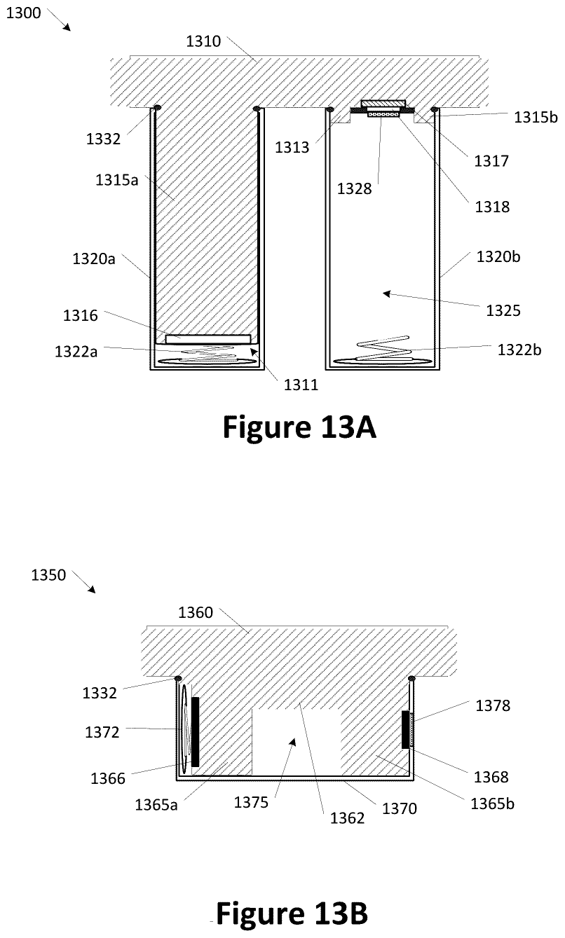

FIG. 13A shows an illustrative cross-sectional view of an interface between a first electrical connection portion 1315a of an illustrative battery runtime extender 1310 and a first battery compartment 1320a of an electronic device and a second electrical connection portion 1315b and a second battery compartment 1320b of the electronic device. The first electrical connection portion 1315a may be a contact carrier capable of positioning an electrical contact 1316 in physical and electrical contact with a negative electrical terminal 1322a within the interior cavity 1311 of the first battery compartment 1320a. The second electrical connection portion 1315b may include one or more structural components 1313 to physically align the electrical connection portion 1315b within the interior cavity 1325 of the second battery compartment 1320b. The second electrical connection portion 1315b may include a contact carrier 1317 to position an electrical contact 1318 in electrical an physical contact with a positive electrical terminal 1328 of the second battery compartment 1320b. In the illustrative example, the electrical connection between the battery runtime extender 1310 and the electronic device associated with the battery compartments 1320a and 1320b may be facilitated via an electrical connection between the negative electrical contact 1322a of the first battery compartment 1320a and the positive electrical terminal of the second battery compartment 1320b, such that the negative electrical contact 1322b remains unconnected. However, in some cases, the battery runtime extender 1310 may include an electrical connection portion that may facilitate the positive electrical connection and the negative electrical connection within a single one (or both) of the first battery compartment 1320a and the second battery compartment 1320b. In some cases, a seal 1332 may be used to prevent ingress of liquid or particulates to the interior cavity 1311 and/or 1325 of the battery compartments 1320a and 1320b

FIG. 13B shows another illustrative cross-sectional view of a battery runtime extender 1360 interfacing with a battery compartment 1370 of an electronic device. In the illustrative example, both the positive electrical contact 1378 and negative electrical contact 1372 are on opposing sidewalls of the battery compartment 1370. Here, the battery runtime extender 1360 may include an electrical connection portion 1362 that may extend within an interior cavity 1375 of the battery compartment 1370. The electrical connection portion 1362 may include a first contact carrier 1365a configured to position a negative electrical contact 1366 for an electrical and physical connection with a negative electrical terminal 1372 of the battery compartment 1370. Similarly, a second contact carrier 1365b may position a positive electrical contact 1368 in physical and electrical contact with a positive electrical contact 1378 of the battery compartment 1378. As mentioned above, a seal 1332 (e.g., a gasket, o-ring, etc.) may be used to prevent ingress of liquids or particulates within the cavity 1375 of the battery compartment 1370.

The above-discussed battery compartments and/or other similar aspects of this disclosure are not intended to be limiting, but have been shown and described for the purposes of illustrating the functional and structural principles of battery compartments designed hold primary and/or secondary batteries to power an associated electronic device. The functional and structural principles are intended to encompass various modifications or configurations that would be within the spirit and scope of the disclosure.

Aspects of the disclosure have been described in terms of illustrative examples thereof. Numerous other examples, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A battery runtime extender physically mounting to a battery compartment opening of an electronic device, comprising:
a housing comprising an upper portion and one or more side portions extending downward from the upper portion to form a cavity within which the electronic device is positioned;
one or more fasteners capable of physically coupling the housing to the electronic device facilitating a seal between the housing and one or more battery compartment openings of the electronic device;
a first contact carrier to position a first electrical contact relative to a first physical location within a first battery compartment of the electronic device; and
a second contact carrier to position a second electrical contact relative to a second physical location within a second battery compartment of the electronic device, wherein the first physical location corresponds to a first electrical contact corresponding to a negative terminal of an electrical bus of the electronic device and the second physical location corresponds to a second electrical contact corresponding to a positive terminal of an electrical bus of the electronic device.

2. The battery runtime extender of claim 1 wherein the electronic device is at least partially enclosed within the cavity.

3. The battery runtime extender of claim 1, wherein the first contact carrier positions the first electrical contact a first distance below a lower surface of the upper portion of the housing and the second contact carrier positions the second electrical contact a second distance below the lower surface of the upper portion of the housing.

4. The battery runtime extender of claim 3, wherein the first distance below the lower surface of the upper portion of the housing is greater than the second distance below the lower surface of the upper portion of the housing.

5. The battery runtime extender of claim 1, comprising:
a first fastener and a second fastener of the one or more fasteners, each of the first fastener and the second fastener extend through associated channels in the upper portion of the housing to facilitate creation of a physical connection between the battery runtime extender and the electronic device based on rotation of the fastener.

6. The battery runtime extender of claim 5, wherein the first fastener and the second fastener comprise threaded screws and are physically captured within an associated first channel and an associated second channel, respectively.

7. The battery runtime extender of claim 1, further comprising an electrical connector to facilitate communications between the battery runtime extender and a computing device.

8. The battery runtime extender of claim 1, further comprising one or more mounting surfaces, each of the one or more mounting surfaces comprising a face portion and a fastening mechanism recessed within the mounting surface, wherein a battery compartment cover of the electronic device physically attaches to a corresponding mounting surface of the one or more mounting surfaces via the fastening mechanism.

9. The battery runtime extender of claim 8, wherein the fastening mechanism comprises a threaded insert recessed within the mounting surface.

10. The battery runtime extender of claim 1, further comprising:
an electrical connector to facilitate communications between the battery runtime extender and a computing device; and
a first mounting surface and a second mounting surface, each of the first mounting surface and the second mounting surface comprising a face portion and a threaded insert recessed within the mounting surface, wherein the electrical connector is surrounded by one of the first mounting surface and the second mounting surface.

11. The battery runtime extender of claim 1, wherein at least a portion of the first contact carrier and the second contact carrier has a physical shape corresponding to an interior cavity within the battery compartment of the electronic device.

12. The battery runtime extender of claim 1, wherein the upper portion of the housing encloses electronics to monitor power flow from the battery runtime extender and to the electronic device.

13. A battery runtime extender physically mounting to a battery compartment opening of an electronic device comprising:
a housing comprising an upper portion and one or more opposing side portions, wherein the upper portion and the one or more side portions define a cavity;
two or more electrical system interface components, wherein a first electrical system interface component comprises a positive electrical terminal and a second electrical system interface component comprises a negative electrical terminal, wherein the first electrical system interface component and the second electrical system interface component extend from the upper portion of the housing into the cavity; and
one or more physical interface components, wherein each physical interface component comprises a fastener, wherein each of the physical interface components form a physical connection between a housing of an electronic device and a portion of the housing of the battery runtime extender forming an opening of one or more battery compartments of the electronic device, wherein the physical interface components further facilitates a continuous electrical connection of the first electrical system interface component to a positive node of an electrical bus of an electronic device within a first battery compartment of the electronic device and of the second electrical system interface component to a negative node of the electrical bus of the electronic device within a second battery compartment of the electronic device.

14. The battery runtime extender of claim 13, wherein the upper portion of the housing encloses electronics to power flow from the battery runtime extender and to the electronic device and the opposing side portions of the housing enclose one or more battery cells.

15. The battery runtime extender of claim 13, further comprising:
an electrical connector to facilitate communications between the battery runtime extender and a computing device; and
a first mounting surface and a second mounting surface, each of the first mounting surface and the second mounting surface comprising a face portion and a threaded insert recessed within the mounting surface, wherein the electrical connector is surrounded by one of the first mounting surface and the second mounting surface.

16. The battery runtime extender of claim 13, wherein internal battery cells enclosed by the housing are configured to provide electrical power to an electronic device via electrical terminals disposed internally to the electronic device.

17. The battery runtime extender of claim 16, wherein the electrical terminals disposed internally to the electronic device are within one or more battery compartments of the electronic device.

18. The battery runtime extender of claim 13, wherein each of the two or more electrical system interface components comprises a surface that at least partially mimics an internal physical shape of a battery compartment of the electronic device.

19. The battery runtime extender of claim 18, wherein a first surface of the first electrical system interface component comprises a first length relative to an under surface of the upper portion and a second surface of the second electrical system interface component comprises a second length relative to an under surface of the upper portion, wherein the first length is different than the second length.

20. A battery runtime extender physically mounting to a battery compartment opening of an electronic device comprising:
a housing comprising an upper portion and two side portions, wherein the upper portion and the two side portions define a cavity within which an electronic device is located during use;
two or more electrical system interface components, wherein a first electrical system interface component comprises a positive electrical terminal and a second electrical system interface component comprises a negative electrical terminal, wherein the first electrical system interface component and the second electrical system interface component extend from the upper portion of the housing into a battery compartment of the electronic device; and
one or more physical interface extensions, wherein each physical interface extension comprises a threaded insert, wherein each of the physical interface components form a physical connection between a battery compartment cover of an electronic device and the housing of the battery runtime extender; and
wherein one or more physical interface components further facilitates a continuous electrical connection of the first electrical system interface component to a positive node of an electrical bus of an electronic device and of the second electrical system interface component to a negative node of the electrical bus of the electronic device.
